(19) United States
(12) Patent Application Publication
(10) Pub. No.: US 2017/0192555 A1
(43) Pub. Date: Jul. 6, 2017

(54) CAPACITIVE TOUCH DEVICE AND DETECTION METHOD OF CAPACITIVE TOUCH PANEL THEREOF

(71) Applicant: HIMAX TECHNOLOGIES LIMITED, Tainan City (TW)

(72) Inventors: Jui-Ni Li, Tainan City (TW); Yaw-Guang Chang, Tainan City (TW)

(21) Appl. No.: 14/989,396

(22) Filed: Jan. 6, 2016

(51) Int. Cl. G06F 3/044

(52) U.S. Cl. CPC G06F 3/044

(57) ABSTRACT

A capacitive touch device and a detection method of a capacitive touch panel thereof are provided. The capacitive touch device includes a plurality of touch electrodes, a detector unit, a plurality of switch units and a touch point determination unit. The detector unit is used for providing a plurality of capacitances after detecting the touch electrodes. The switch units couple the detector unit to the touch electrodes and provide a ground voltage to the touch electrodes which are not coupled to the detector unit. The touch point determination unit is coupled to the detector unit to determine whether the touch electrodes are touched according the capacitances and provides touch information accordingly.

### BACKGROUND OF THE INVENTION

1. Field of the Invention

The invention relates to a touch device, and particularly relates to a capacitive touch device and a detection method of a capacitive touch panel thereof.

2. Description of Related Art

Information technologies (ITs), wireless mobile communication, and information home appliances have been rapidly developed and widely applied. To meet current demands of being portable, compact, and user-friendly, touch panels have been adopted as input device in replacement of conventional keyboards or mice in many electronic devices. Currently, touch panels can be categorized into capacitive touch panels and resistive touch panels. Due to its better sensing effect, the capacitive touch panels have become the mainstream of touch panels nowadays.

Capacitive touch panels mainly rely on capacitance variation of touch electrodes to detect a touched point, and electrical properties of a capacitive touch panel may be influenced by process and stack structure. When the equivalent capacitance variation of the capacitive touch panel is too low, the touched point may not be accurately detected. Thus, how to accurately detect the touched point when the equivalent capacitance variation of the capacitive touch panel is too low remains an issue in the development of touch panel.

### SUMMARY OF THE INVENTION

The invention provides a capacitive touch device and a detection method of a capacitive touch panel thereof capable of increasing a capacitance variation of a touch electrode when a finger or a touch pen touches.

An embodiment of the invention provides a capacitive touch device. The capacitive touch device includes a plurality of touch electrodes, a detector unit, a plurality of switch units, and a touch point determination unit. The detector unit detects the touch electrodes and provides a plurality of capacitances. The switch units are coupled to the detector unit and the touch electrodes and receive a ground voltage. The switch units couple the detector unit to the touch electrodes and provide the ground voltage to the touch electrodes not coupled to the detector unit. The touch point determination unit is coupled to the detector unit, determines whether the touch electrodes are touched based on the capacitances, and correspondingly provides touch information.

An embodiment of the invention provides a detection method of a capacitive touch panel. The capacitive touch panel is located in a capacitive touch device. The method includes steps as follows. A detector unit and a plurality of touch electrodes are coupled through a plurality of switch units, and a ground voltage is provided to the touch electrodes not coupled to the detector unit through the switch units. The touch electrodes are detected by using the detector unit and a plurality of capacitances are provided. Whether the touch electrodes are touched based on the capacitances is determined by using a touch point determination unit, and touch information is correspondingly provided based on whether the touch electrodes are touched.

Based on above, in the capacitive touch device and the detection method of the capacitive touch panel thereof according to the embodiments of the invention, the touch electrodes that are not coupled to the detector unit are coupled to the ground voltage, so that the touching finger or touch pen forms the equivalent capacitances with the grounded touch electrodes. Accordingly, the capacitance variation of the touch electrode is increased when the finger or the touch pen touches.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a system of a capacitive touch device according to an embodiment of the invention.

FIGS. 2A and 2B are schematic views illustrating equivalent capacitances when touch electrodes according to an embodiment of the invention are not touched.

FIGS. 3A and 3B are schematic views illustrating equivalent capacitances when a touch electrode according to an embodiment of the invention is touched.

FIGS. 4A and 4B are schematic views illustrating equivalent capacitances when the touch electrode is touched and other touch electrodes are not coupled to a ground voltage.

FIG. 5 is a schematic view illustrating grouping of a capacitive touch panel according to an embodiment of the invention.

FIG. 6 is a schematic view illustrating a circuit of a switch unit according to an embodiment of the invention.

FIG. 7 is a flowchart illustrating a detection method of a capacitive touch panel according to an embodiment of the invention.

### DESCRIPTION OF THE EMBODIMENTS

Reference will now be made in detail to the embodiments of the disclosure, examples of which are illustrated in the accompanying drawings. Wherever possible, the same reference numbers are used in the drawings and the description to refer to the same or like parts.

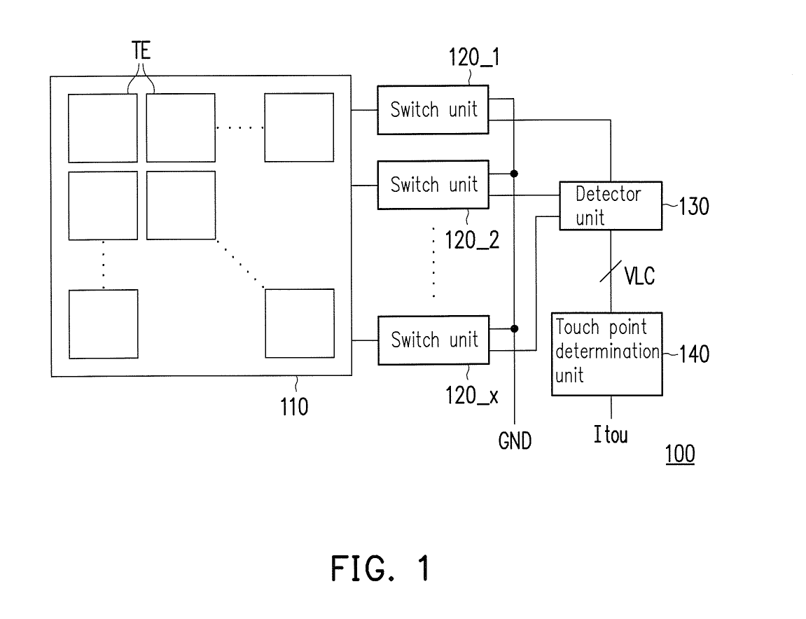

FIG. 1 is a schematic view illustrating a system of a capacitive touch device according to an embodiment of the invention. Referring to FIG. 1, in this embodiment, a capacitive touch device 100 includes an electrical touch panel 110, a plurality of switch units 120_1 to 120_x, a detector unit 130, and a touch point determination unit 140, for example. In addition, the electrical touch panel 110 includes a plurality of touch electrodes TE arranged in an array, and each of the touch electrodes TE corresponds to a switch unit (e.g., 120_1 to 120_x). Namely, x is a positive integer and is equal to the number of the touch electrodes TE.

Each of the switch units (e.g., 120_1 to 120_x) is coupled to the detector unit 130 and one of the touch electrodes TE, and receives a ground voltage GND. When the electrical touch panel 110 scans, at least one switch unit (e.g., 120_1 to 120_x) couples the detector unit 130 to the corresponding touch electrode TE, and rest of the switch units (e.g., 120_1 to 120_x) provide the ground voltage GND to the corresponding touch electrodes TE. Namely, the touch electrodes TE that are not coupled to the detector unit 130 are coupled to the ground voltage GND. When the electrical touch panel 110 does not scan (i.e., in an idle state), the switch units 120_1 to 120_x may provide the ground voltage GND to all the touch electrodes TE or make all the touch electrodes TE in a floating state, depending on an arrangement made by people having ordinary skills in the art.

After the detector unit 130 is coupled to the touch electrode TE, the touch electrode TE that is coupled is detected. In addition, after detection, the detector unit 130 may provide a multiple-bit logical value VLC to represent a current equivalent capacitance of the touch electrode TE. Namely, each of the touch electrodes TE corresponds to a logical value VLC. The touch point determination unit 140 is coupled to the detector unit 130, so as to receive the logical values VLC corresponding to all the touch electrodes TE. In addition, when the touch point determination unit 140 receives the corresponding logical values VLC of all the touch electrodes TE, the touch point determination unit 140 may determine whether the touch electrodes TE are touched based on the capacitances represented by the logical values VLC and correspondingly provide touch information Itou.

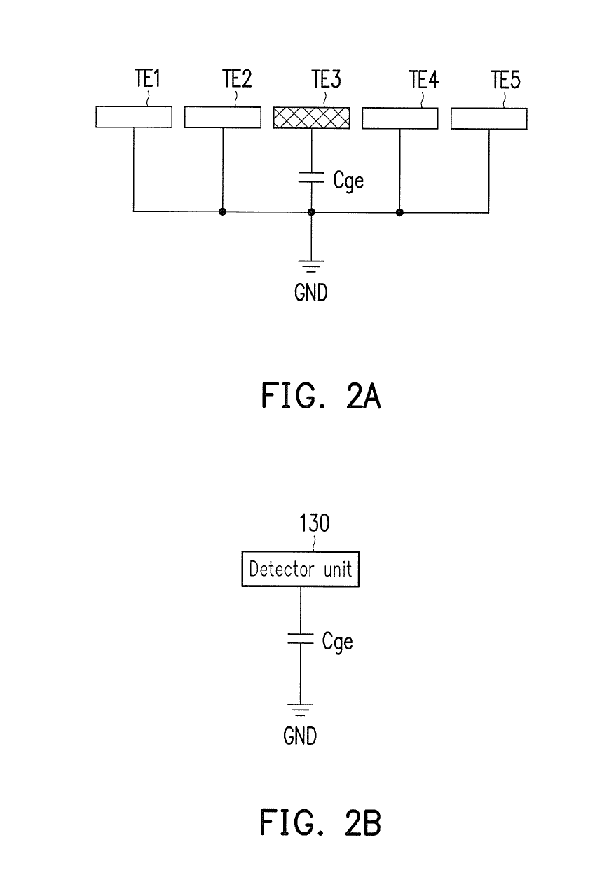

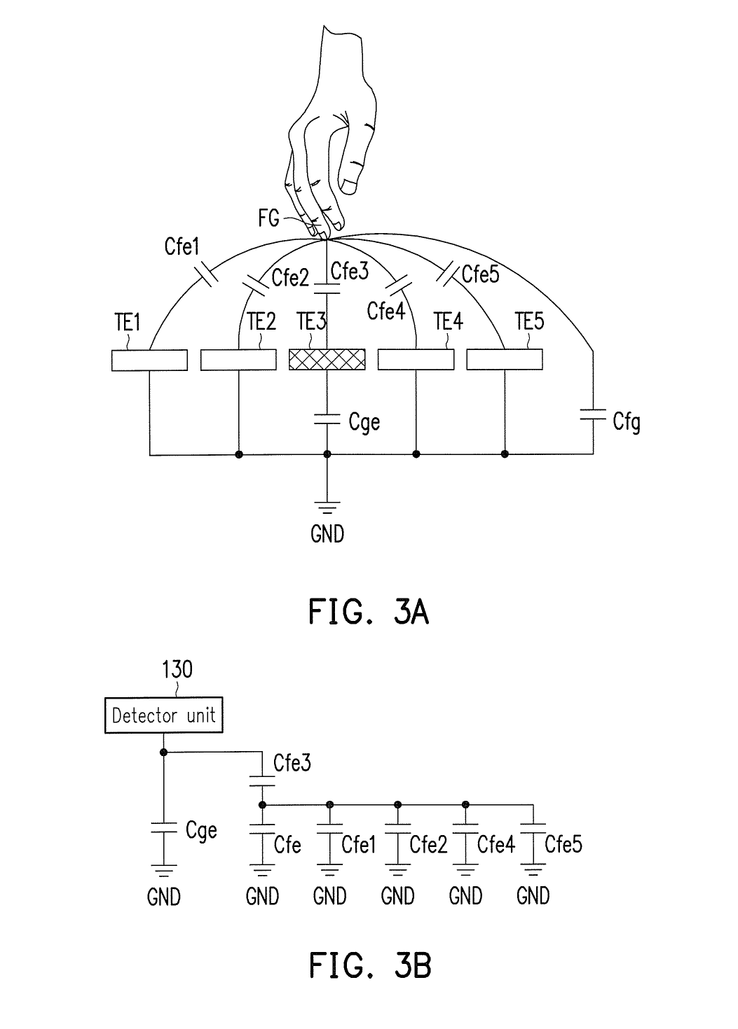

FIGS. 2A and 2B are schematic views illustrating equivalent capacitances when touch electrodes according to an embodiment of the invention are not touched. FIGS. 3A and 3B are schematic views illustrating equivalent capacitances when a touch electrode according to an embodiment of the invention is touched. Referring to FIGS. 1, 2A, 2B, 3A, and 3B, in this embodiment, it is assumed that the detector unit 130 includes an analog-to-digital converter, for example, and the switch units 120_1 to 120_x sequentially couple the analog-to-digital converter to the touch electrodes TE one by one. Then, after detecting one of the touch electrodes, the analog-to-digital converter provides the corresponding logical value VLC to the touch point determination unit 140.

Referring to FIGS. 2A, 2B, 3A, and 3B, five touch electrodes TE1 to TE5 are provided herein for descriptions. When a finger FG (or a touch pen) does not touch the touch electrode TE (the touch electrode TE3, for example) coupled to the detector unit 130, an equivalent capacitance Cge is present between the touch electrode TE3 and the ground voltage GND, and no other equivalent capacitance is formed. Namely, the detector unit 130 only detects a capacitance of the equivalent capacitance Cge. When the finger (or touch pen) touches the touch electrode TE3 coupled to the detector unit 130, equivalent capacitances Cfe1 to Cfe5 are also formed between the touch electrodes TE1 to TE5 and the finger FG in addition to the equivalent capacitance Cge. Also, an equivalent capacitance Cfg is also formed between the finger FG and the ground voltage GND. Namely, a capacitance detected by the detector unit 130 is Cge+(Cfe3//(Cfg+Cfe1+Cfe2+Cfe4+Cfe5)), wherein a capacitance variation of the touch electrode TE3 is Cfe3//(Cfg+Cfe1+Cfe2 +Cfe4+Cfe5).

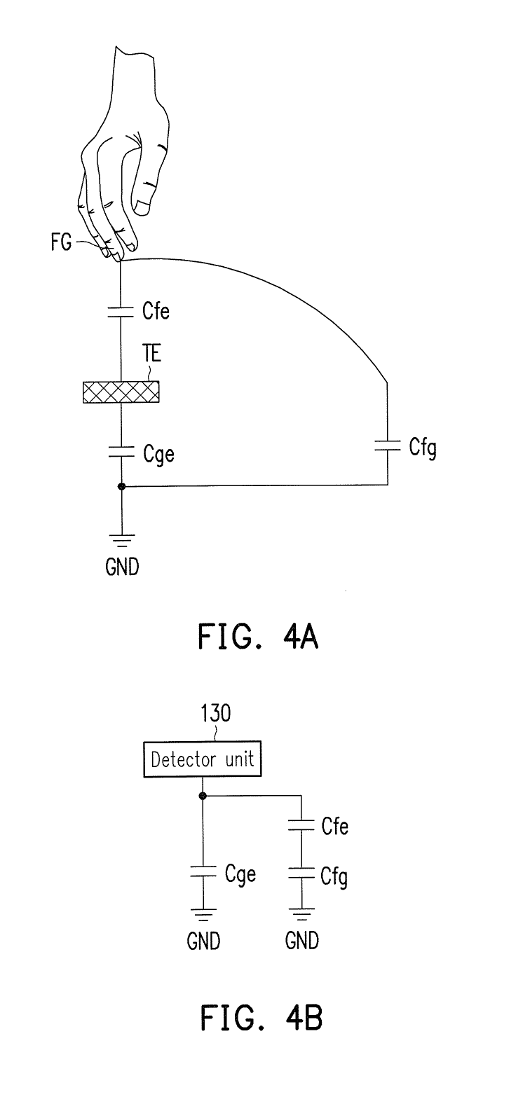

FIGS. 4A and 4B are schematic views illustrating equivalent capacitances when the touch electrode is touched and the touch electrodes are detected at the same time. Referring to FIGS. 4A, and 4B, in this embodiment, it is assumed that all the touch electrodes TE are detected at the same time. Namely, no touch electrode TE is grounded. At this time, the touch electrodes TE are considered as electrically independent. Thus, when the touch electrode TE is touched by the finger FG (or touch pen), the equivalent capacitance Cfe is formed between the touch electrodes TE and the finger FG, and the equivalent capacitance Cfg is formed between the finger FG and the ground voltage GND. Namely, the capacitance that the detector unit 130 detects is Cge+Cfe//Cfg, and the capacitance variation of the touch electrodes TE is Cfe//Cfg. In addition, the capacitance Cfe is approximately equivalent to the capacitance Cfe3.

Referring to FIGS. 3A, 3B, 4A, and 4B, since Cfg+Cfe1+Cfe2+Cfe4+Cfe5 is greater than Cfg, Cfe3//(Cfg+Cfe1+Cfe2+Cfe4+Cfe5) is greater than Cfe//Cfg. Namely, the capacitance variation detected when rest of the touch electrodes are grounded is higher than the capacitance variation detected when rest of the touch electrodes are not grounded. Therefore, the touch sensitivity of the touch device and the identification of the touch point are enhanced.

In the above embodiment, the detector unit 130 includes an analog-to-digital converter, for example. However, in other embodiments, the detector unit 130 may include a plurality of analog-to-digital converters to detect the touch electrodes TE at the same time and provide the corresponding logical values VLC. The touch electrodes TE that are not detected are coupled to the ground voltage GND. Accordingly, the number of analog-to-digital converters may be reduced to reduce a hardware cost of the capacitive touch device.

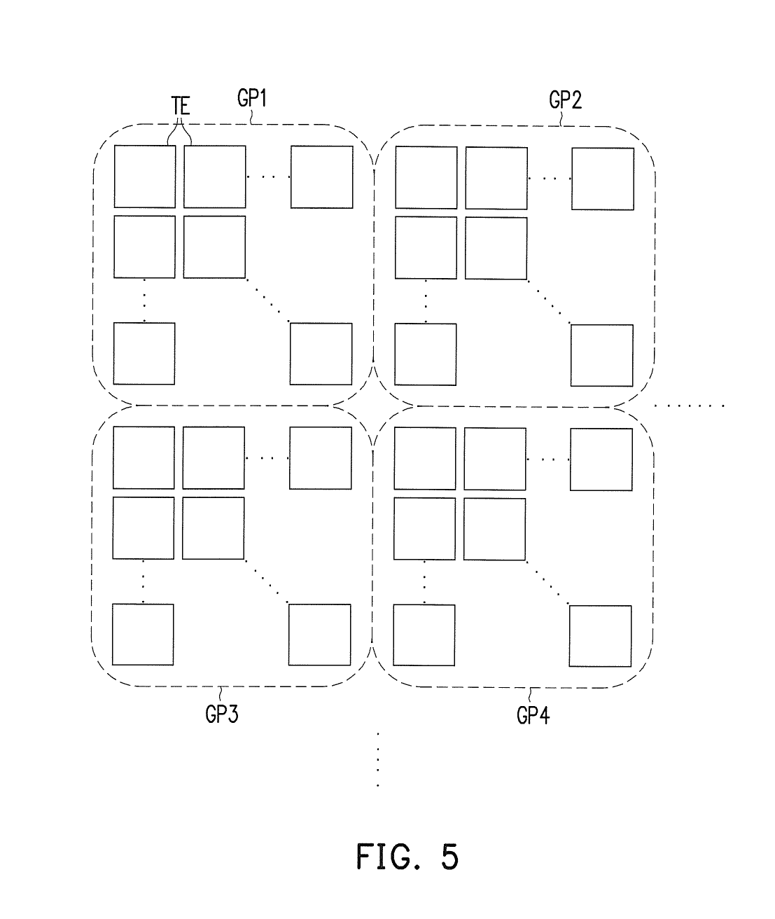

FIG. 5 is a schematic view illustrating grouping of a capacitive touch panel according to an embodiment of the invention. Referring to FIGS. 1 and 5, in this embodiment, the touch electrodes TE on the capacitive touch panel are divided into a plurality of groups (e.g., GP1 to GP4), and the touch electrodes TE of the respective groups (e.g., GP1 to GP4) may be detected independently. The detection thereof follows the embodiments shown in FIGS. 1, 2A, 2B, 3A, and 3B. In other words, each of the groups (e.g., GP1 to GP4) corresponds to n analog-to-digital converters, and n is a positive integer. When each of the groups (e.g., GP1 to GP4) corresponds to one analogue-to-digital converter, one touch electrode TE is detected at a time in each of the groups (e.g., GP1 to GP4). When each of the groups (e.g., GP1 to GP4) corresponds to two analog-to-digital converters, two touch electrodes TE are detected at a time, and so on so forth.

Besides, scanning of the respective groups (e.g., GP1 to GP4) may be synchronized. Namely, detection directions of the touch electrodes TE of the respective groups (e.g., GP1 to GP4) may be completely the same. In other words, the detection directions of the touch electrodes TE of the respective groups (e.g., GP1 to GP4) may be in a Z-shape or N-shape synchronous scanning pattern from the upper left corner to the lower right corner of the figure. Alternatively, the scanning of the respective groups (e.g., GP1 to GP4) may not be synchronized. Namely, the detection directions of the touch electrodes of the respective groups (e.g., GP1 to GP4) may not be exactly the same. In other words, the detection directions and starting positions of the touch electrodes TE of the respective groups (e.g., GP1 to GP4) may be arbitrarily set. The embodiments of the invention are not limited thereto. When the scanning of the respective groups (e.g., GP1 to GP4) proceeds synchronously, equivalent capacitance structures of the detected touch electrodes TE are approximately the same, so as to approximate capacitance variations of the capacitive touch panel (e.g., 110).

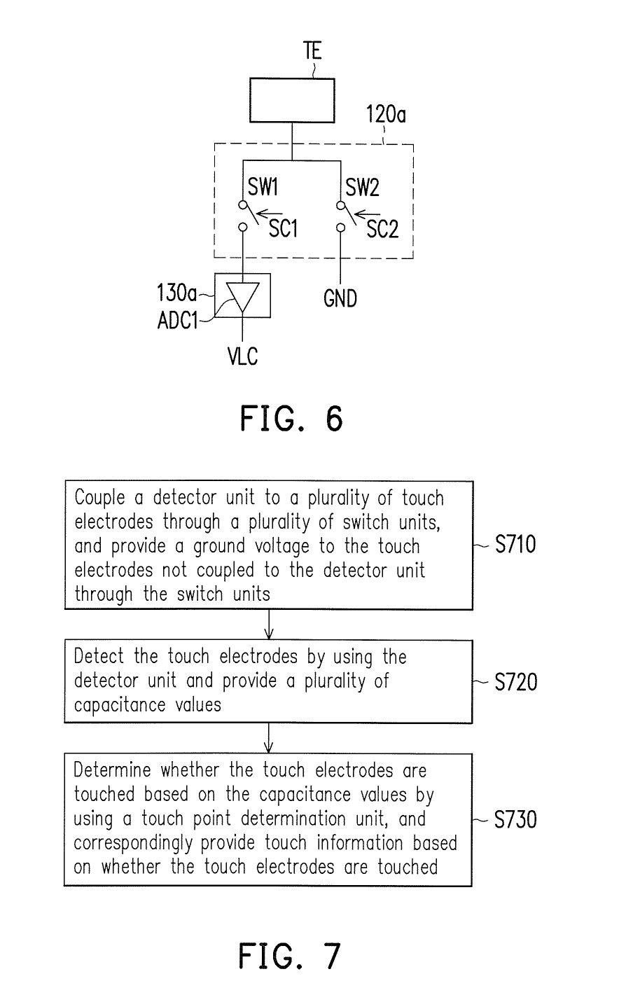

FIG. 6 is a schematic view illustrating a circuit of a switch unit according to an embodiment of the invention. Referring to FIGS. 1 and 6, in this embodiment, each switch unit 120a includes a first switch SW1 and a second switch SW2. The first switch SW1 receives a switch signal SC1, and is coupled between the corresponding touch electrode TE and an analog-to-digital converter ADC1 of the detector unit 130a. The second switch SW2 receives a switch signal SC2, and is coupled between the corresponding touch electrode TE and the ground voltage GND. In addition, at least one of the first switch SW1 and the second switch SW2 is cut off, and the switch signals SC1 and SC2 may be provided by the touch point determination unit 140 or an additional control circuit, depending on an arrangement made by people having ordinary skills in the art.

FIG. 7 is a flowchart illustrating a detection method of a capacitive touch panel according to an embodiment of the invention. Referring to FIG. 7, in this embodiment, the capacitive touch panel is located in a capacitive touch device, and the detection method includes steps as follows. First of all, a detector unit is coupled to a plurality of touch electrodes through a plurality of switch units, and a ground voltage is provided to the touch electrodes not coupled to the detector unit through the switch units (Step S710). Then, the detector unit detects the touch electrodes and provides a plurality of capacitances (Step S720). Then, through a touch point determination unit, whether the touch electrodes are touched is determined based on the capacitances, and touch information is correspondingly provided based on whether the touch electrodes are touched (Step S730). Here, the order of Steps S710, S720, and S730 is described herein for an illustrative purpose, and the embodiments of the invention are not limited thereto. Also, details of Steps S710, S720, and S730 may be referred to the embodiments shown in FIGS. 1, 2A, 2B, 3A, 3B, 5, and 6, and thus will not be repeated in the following.

In view of the foregoing, in the capacitive touch device and the detection method of the capacitive touch panel thereof according to the embodiments of the invention, the touch electrodes that are not coupled to the detector unit are coupled to the ground voltage, so that the touching finger or touch pen forms the equivalent capacitances with the grounded touch electrodes. Accordingly, the capacitance variation of the touch electrode is increased when the finger or the touch pen touches so as to enhance the touch sensitivity of the touch device and the identification of the touch point.

It will be apparent to those skilled in the art that various modifications and variations can be made to the structure of the disclosure without departing from the scope or spirit of the disclosure. In view of the foregoing, it is intended that the disclosure cover modifications and variations of the disclosure provided they fall within the scope of the following claims and their equivalents.

What is claimed is:

1. A capacitive touch device, comprising:
a plurality of touch electrodes;
a detector unit, detecting the touch electrodes and providing a plurality of capacitances;
a plurality of switch units, coupled to the detector unit and the touch electrodes and receiving a ground voltage, wherein the switch units couple the detector unit to the touch electrodes and provide the ground voltage to the touch electrodes not coupled to the detector unit; and
a touch point determination unit, coupled to the detector unit, determining whether the touch electrodes are touched based on the capacitances, and correspondingly providing touch information.

2. The capacitive touch device as claimed in claim 1, wherein the touch electrodes are arranged in an array.

3. The capacitive touch device as claimed in claim 1, wherein the detector unit comprises an analog-to-digital converter, the switch units sequentially couple the analog-to-digital converter to the touch electrodes one by one and the analog-to-digital converter detects one of the touch electrodes and provides a corresponding capacitance.

4. The capacitive touch device as claimed in claim 1, wherein the detector unit comprises a plurality of analog-to-digital converters to respectively detect the corresponding touch electrodes and provide corresponding capacitances.

5. The capacitive touch device as claimed in claim 4, wherein the touch electrodes are divided into a plurality of groups, and each of the groups corresponds to n analog-to-digital converters, n being a positive integer.

6. The capacitive touch device as claimed in claim 5, wherein detection directions of the touch electrodes of the respective groups are the same.

7. The capacitive touch device as claimed in claim 5, wherein detection directions of the touch electrodes of the respective groups are not exactly the same.

8. The capacitive touch device as claimed in claim 1, wherein each of the switch units comprises:
a first switch, coupled between the corresponding touch electrode and the detector unit; and
a second switch, coupled between the corresponding touch electrode and the ground voltage,
wherein at least one of the first switch and the second switch is turned off.

9. A detection method of a capacitive touch panel, wherein the capacitive touch panel is located in a capacitive touch device, the method comprising:
coupling a detector unit and a plurality of touch electrodes through a plurality of switch units, and providing a ground voltage to the touch electrodes not coupled to the detector unit through the switch units;
detecting the touch electrodes by using the detector unit and providing a plurality of capacitances; and
determining whether the touch electrodes are touched based on the capacitances by using a touch point determination unit, and correspondingly providing touch information based on whether the touch electrodes are touched.

10. The detection method of the capacitive touch panel as claimed in claim 9, wherein the touch electrodes are arranged in an array.

11. The detection method of the capacitive touch panel as claimed in claim 9, wherein the detector unit comprises an analog-to-digital converter, and the step of detecting the touch electrodes by using the detector unit and providing the capacitances comprises:
sequentially coupling the analog-to-digital converter to the touch electrodes one by one through the switch units; and
detecting one of the touch electrodes by using the analog-to-digital converter and providing a corresponding capacitance.

12. The detection method of the capacitive touch panel as claimed in claim 9, wherein the detector unit comprises a plurality of analog-to-digital converters, and the step of detecting the touch electrodes by using the detector unit and providing the capacitances comprises:
respectively detecting the corresponding touch electrodes by using the analog-to-digital converters and providing corresponding capacitances.

13. The detection method of the capacitive touch panel as claimed in claim 12, wherein the touch electrodes are divided into a plurality of groups, and each of the groups corresponds to n analog-to-digital converters, n being a positive integer.

14. The detection method of the capacitive touch panel as claimed in claim 13, wherein detection directions of the touch electrodes of the respective groups are the same.

15. The detection method of the capacitive touch panel as claimed in claim 13, wherein detection directions of the touch electrodes of the respective groups are not exactly the same.
